(19) United States
(12) Patent Application Publication
(10) Pub. No.: US 2012/0323763 A1
(43) Pub. Date: Dec. 20, 2012

(54) Systems and methods for monitoring and managing transportation infrastructure and locations of vehicles therein

(76) Inventor: Joseph Michael, Los Angeles, CA (US)

(21) Appl. No.: 13/161,483

(22) Filed: Jun. 15, 2011

(51) Int. Cl. G08G 1/123; G06F 17/00; G06Q 10/00; G06Q 40/00

(52) U.S. Cl. 705/39; 705/418; 340/988; 701/1

(57) ABSTRACT

A method for monitoring and managing transportation infrastructure and locations of vehicles therein includes: receiving signals transmitted from a vehicle equipped with a transmitter that generates the signals, the signals including information relating to one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle; and processing the signals and/or the information to identify in association with the vehicle a circumstance that satisfies criteria for facilitating, controlling, or initiating an action or a process involving one or more of providing information, providing a notification, transferring funds, and issuing a ticket, a citation, a warning, or other communication.

### TECHNICAL FIELD

The present invention relates generally to monitoring locations of objects and, in particular, systems and methods for monitoring and managing locations of vehicles within a transportation infrastructure, or other environment within which vehicles change locations or park, utilizing information that identifies or uniquely identifies a vehicle.

### BACKGROUND ART

Transportation infrastructures provide many benefits to societies in addition to potentially increasing the efficiency and cost effectiveness of moving large numbers of people, goods, and/or other objects from one location to another. A significant challenge in relation to maintaining and successfully managing transportation infrastructures is how to simultaneously accommodate the sometimes conflicting requirements, goals, interests, or preferences of, for example, rush-hour commuters and law enforcement agencies.

Another key consideration in transportation infrastructure management is safety, for example, attempts are often made to strike an appropriate balance between a desire to effectively enforce traffic laws and a need in some circumstances to allow the vast majority of vehicles to continue moving through infrastructure networks (e.g., roads, highways, checkpoints) without being stopped or with minimal delays.

Inefficiencies in the process of enforcing traffic laws sometimes result in the additional problem of failing to timely notify a driver who is breaking a law that he or she is, in fact, breaking the law and potentially endangering their own life or the lives of others. For example, some cities utilize a highly inefficient system in which cameras are positioned to take a picture of a vehicle's license plate (e.g., as the vehicle traverses an intersection) and, thereafter, mail the owner of the vehicle a picture of their vehicle in a red light violation.

Users of transportation infrastructures could also benefit if certain aspects of moving vehicles from one location to another were less cumbersome and/or expensive. For example, many parking meters (located adjacent to otherwise desirable parking spaces) require a person to get out of the vehicle to put a coin into or otherwise “feed” the meter, which inconvenience is compounded by overpaying for use of the parking space, e.g., when the driver returns to the vehicle sooner than expected and time (already paid for, but nonrefundable as an expenditure) remains on the parking meter.

Accordingly, it would be useful to be able to provide an apparatus or method for monitoring and managing transportation infrastructure that addresses one or more of the foregoing considerations, or that provides a benefit such as improved efficiency, costs savings, or better or more informed decision making processes, for example, in relation to management of transportation infrastructures. It would also be useful to be able to monitor and manage locations of vehicles, persons, and/or objects in relation to an area or region of interest or concern.

### SUMMARY OF THE INVENTION

In an example embodiment, an apparatus for monitoring and managing transportation infrastructure and locations of vehicles therein includes: an electronic tracking device with a transmitter that generates signals that include information relating to one or more of a vehicle equipped with the electronic tracking device, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle.

In an example embodiment, a method for monitoring and managing transportation infrastructure and locations of vehicles therein includes: receiving signals transmitted from a vehicle equipped with a transmitter that generates the signals, the signals including information relating to one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle; and processing the signals and/or the information to identify in association with the vehicle a circumstance that satisfies criteria for facilitating, controlling, or initiating an action or a process involving one or more of providing information, providing a notification, transferring funds, and issuing a ticket, a citation, a warning, or other communication.

In an example embodiment, an apparatus for monitoring and managing usage of a parking space includes: a parking meter that facilitates providing information including a parking meter start time, a parking meter stop time, and an association between the parking meter and an account, and initiates or requests a transaction in which the account is charged depending upon an amount of time passing between the start time and the stop time.

In an example embodiment, a method for monitoring and managing usage of a parking space includes: accessing information that includes a parking meter start time, a parking meter stop time, and an association between the parking meter and an account, the information resulting from a process of reading a code, the code identifying or being associated with one of the parking meter and the account; and facilitating or initiating a process of charging the account depending upon an amount of time passing between the parking meter start and stop times.

### BRIEF DESCRIPTION OF THE DRAWINGS

FIG. 1 shows an example implementation of a system for monitoring and managing transportation infrastructure and locations of vehicles therein;

FIG. 2 shows an example electronic tracking device suitable for the system of FIG. 1;

FIG. 3 shows an example implementation of a method for monitoring and managing transportation infrastructure and locations of vehicles therein;

FIG. 4 shows an example interactive interface presenting a visual representation of a region, vehicles within the region, and information associated with the vehicles;

FIG. 5 shows another example interactive interface presenting a visual representation of a region, a restricted area within the region, vehicles within the region, and information associated with the vehicles;

FIG. 6 shows an example apparatus for monitoring and managing usage of a parking space;

FIG. 6A shows an image capture/code reader device capturing an image of code provided on or generated by the parking meter apparatus of FIG. 6;

FIG. 7 shows another example apparatus for monitoring and managing usage of a parking space;

FIG. 7A shows code generated by a code generator device being captured by the image capture/code reader device of the parking meter apparatus of FIG. 7; and

FIG. 8 shows an example implementation of a method for monitoring and managing usage of a parking space.

### DISCLOSURE OF INVENTION

Example embodiments described herein involve methods and technologies for monitoring and managing transportation infrastructure and locations of vehicles therein. For purposes of this disclosure, the term “transportation infrastructure” includes, by way of example, but not of limitation: road and highway networks in addition to parking spaces and facilities associated therewith and/or accessible thereby, including structures (bridges, tunnels, culverts, retaining walls), signage and markings, electrical systems (street lighting and traffic lights), edge treatments (curbs, sidewalks, landscaping) and specialized facilities such as road maintenance depots and rest areas; railways, including structures, terminal facilities (rail yards, train stations), level crossings, signalizing and communications systems; canals and navigable waterways requiring continuous maintenance (dredging, etc.); seaports and lighthouses; airports, including air navigational systems; mass transit systems (commuter rail systems, subways, tramways, trolleys and bus transportation); bicycle paths and pedestrian walkways; and ferries. For purposes of this disclosure, the term “vehicles” includes, by way of example, but not of limitation: motorized vehicles, non-motorized vehicles, road vehicles, all-terrain vehicles, railway vehicles, amphibious vehicles, as well as watercraft, hovercraft, aircraft, spacecraft, and other vehicles and vessels. Example embodiments of the methods and technologies described herein facilitate monitoring and managing transportation infrastructure and locations of vehicles therein. Other example embodiments of the methods and technologies described herein facilitate monitoring and managing locations of vehicles, persons, and/or objects in relation to an area or region of interest or concern, independent of whether the area or region includes, constitutes, facilitates, provides access to, or is a part of a transportation infrastructure.

In an example method, a network (or other communication means) is utilized to provide user interfaces at personal computing devices, or at other devices capable of generating interfaces (e.g., interactive displays), in response to commands received and/or resources accessed via the network.

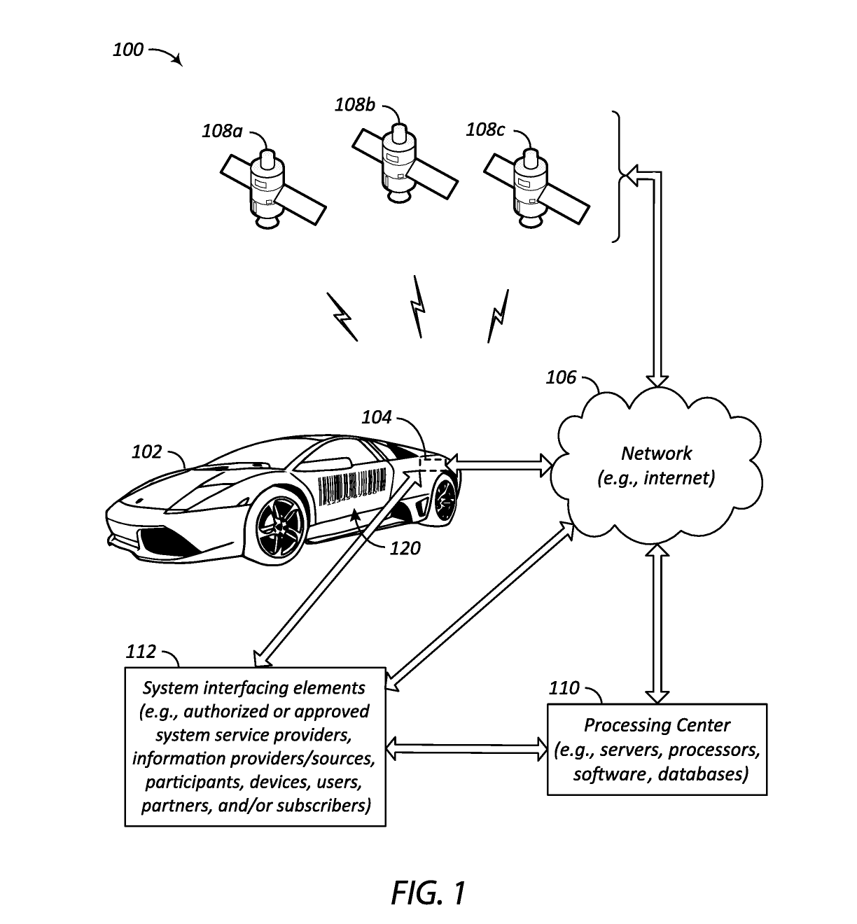

FIG. 1 shows an example implementation of a system 100 for monitoring and managing transportation infrastructure and locations of vehicles therein. In this example implementation, a vehicle 102 is equipped with an electronic tracking device 104 (shown in dashed lines) configured to communicate with a network 106 (e.g., the internet) via satellites 108a, 108b, and 108c. In this example implementation, the network 106 is also utilized to facilitate communications links between a processing center 110 (e.g., implemented in the form of servers, processors, or the like operating under the control of software and/or other sources of commands or inputs), system interfacing elements 112 (e.g., authorized or approved system service providers, information providers/sources, participants, devices, users, partners, and/or subscribers), and the electronic tracking device 104.

For purposes of this disclosure, the term “electronic tracking device” includes, by way of example, but not of limitation: any device attached to a vehicle or other movable thing that reveals its location or movement by transmission of electronic signals. In an example embodiment, the electronic tracking device 104 includes a Global Positioning System (GPS) tracking device or unit (e.g., a GPS module configured to receive GPS signals from the satellites 108a, 108b, and 108c and calculate coordinates) and a modem or other communications device configured to transmit location and telemetry input data.

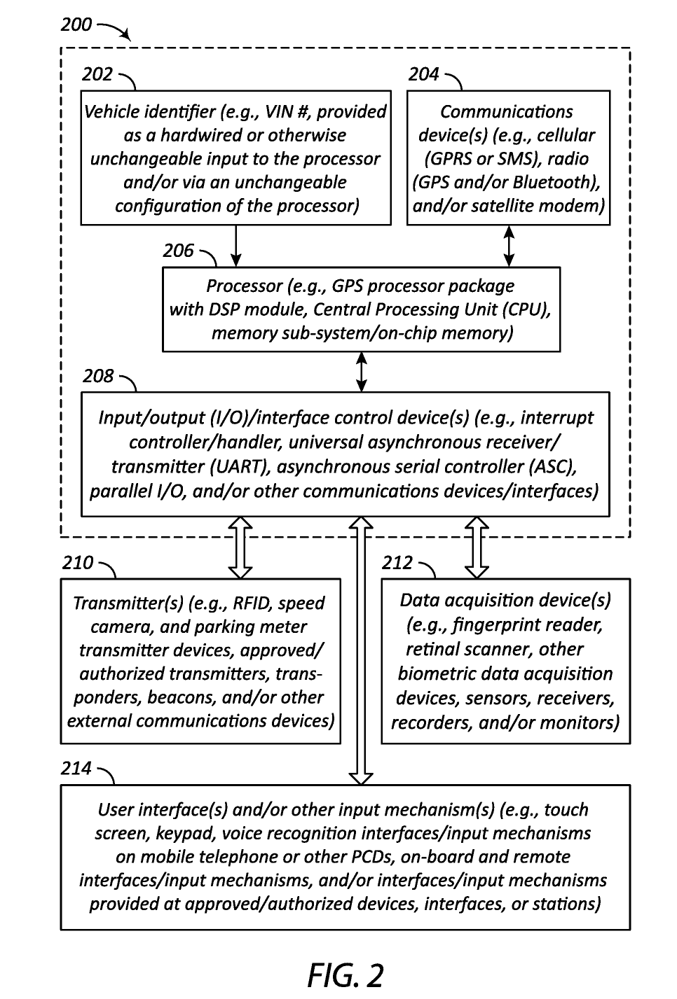

Referring to FIG. 2, an example electronic tracking device 200 (suitable for the system 100 for monitoring and managing transportation infrastructure and locations of vehicles therein) includes a vehicle identifier 202, communications device(s) 204, a processor 206, and input/output (I/O)/interface control device(s) 208 configured as shown. When a vehicle is registered, a license plate is issued. All vehicles are identified with a particular Vehicle Identification Number (VIN) or the Hull Identification Number (HIN) for vessels/boats. Each year the registration establishes the registered owner and also the lienholder. By way of example, the vehicle identifier 202 can be the VIN of the vehicle equipped with the electronic tracking device 200 or other numbers, letters, characters, symbols, codes, or the like, whether human-readable, machine-readable, or both. In an example embodiment, the vehicle identifier 202 includes, represents, and/or provides vehicle identification information that uniquely identifies the vehicle equipped with the electronic tracking device 200. In an example embodiment, the electronic tracking device 200 is configured such that the vehicle identification information cannot be changed or prevented from being transmitted during normal operation of the electronic tracking device. By way of example, the vehicle identifier 202 is implemented/provided as a hardwired or otherwise unchangeable input to the processor 206 and/or via an unchangeable configuration of the processor 206. Moreover, in an example embodiment, the electronic tracking device 200 is configured such that an attempt to change, modify, damage, make unauthorized alterations to, or otherwise tamper with the vehicle identifier 202 and/or processor 206 results in an alert or alarm being generated, e.g., transmitted by the communications device(s) 204 to one or more of, for example: a state, a county, a city, a town, a municipality, a court, a government agency, a law enforcement agency, a department of motor vehicles, a parking and/or traffic enforcement agency, a company or other private-sector entity or organization, authorized operators and users of a system for monitoring and managing transportation infrastructure and locations of vehicles therein, an individual or a group, an owner or a registered owner of the vehicle, a person or persons authorized or approved by the owner and/or the registered owner of the vehicle, a lienholder, an insurance company, an authorized or approved source or device, and a processor or controller.

The communications device(s) 204 include, for example, a cellular (GPRS or SMS), radio (GPS), and/or satellite modem. The communications device(s) 204 can include one or more of, for example: modems, transmitters, transponders, beacons, transceivers, and/or receivers. In an example embodiment, the communications device(s) 204 include a communications device that utilizes a short-range wireless technology or standard (e.g., Bluetooth), or a wireless local area network (WLAN) (e.g., based on the IEEE 802.11 standards). Thus, in example embodiments, the electronic tracking device 200 includes a communications device facilitating one or more of cellular, radio and satellite communications.

The processor 206 includes or is implemented utilizing, for example, a GPS processor package with a digital signal processing (DSP) module (for processing signals received from GPS satellites), a Central Processing Unit (CPU), and a memory sub-system/on-chip memory. By way of example, the DSP module includes GPS correlation hardware configured to extract GPS data from incoming intermediate frequency (IF) data, various implementations of which are known to one of ordinary skill in the art.

The input/output (I/O)/interface control device(s) 208 include one or more of, for example: an interrupt controller/handler, a universal asynchronous receiver/transmitter (UART), an asynchronous serial controller (ASC), a parallel I/O, and other communications devices/interfaces. In example embodiments, the electronic tracking device 200 includes one or more devices that serve as both a communications device 204 and an input/output (I/O)/interface control device 208.

The input/output (I/O)/interface control device(s) 208 receive signals that include data, information, commands, and/or other inputs, as shown in FIG. 2, from one or more of: transmitter(s) 210, data acquisition device(s) 212, and user interface(s) and/or other input mechanism(s) 214. The transmitter(s) 210 include one or more of, for example: a radio-frequency identification (RFID) transmitter/transponder, a camera (e.g., a speed camera, hand-held digital camera) equipped with a transmitter or other communications device, a parking meter transmitter device, and approved/authorized transmitters, transponders, beacons, and other external communications devices (i.e., separate from or remotely located in relation to the electronic tracking device 200). The data acquisition device(s) 212 include one or more of, for example: a fingerprint reader, a retinal scanner, and other biometric data acquisition devices, sensors (e.g., blood alcohol sensor), receivers, recorders, and monitors. The user interface(s) and/or other input mechanism(s) 214 include one or more of, for example: a touch screen, a keypad, voice recognition interfaces/input mechanisms on mobile telephones, smartphones, or other personal computing devices (PCDs), on-board and remote interfaces/input mechanisms, and interfaces/input mechanisms provided at approved/authorized devices, interfaces, or stations. In alternative embodiments, one or more of the transmitter(s) 210, the data acquisition device(s) 212, and the user interface(s) and/or other input mechanism(s) 214 are a component, a part, or a peripheral of the electronic tracking device 200.

In an example embodiment, an apparatus for monitoring and managing transportation infrastructure and locations of vehicles therein includes: an electronic tracking device with a transmitter that generates signals that include information relating to (e.g., identifying) one or more of a vehicle equipped with the electronic tracking device (e.g., VIN or other unique identifier), an owner (e.g., registered owner), a driver, a custodian (e.g., renter), or a passenger of the vehicle, a person, an animal, or an object within, secured to, or transported by the vehicle, and a person, an entity, an object, a status, a condition, an event, an indication, or an interrupt associated with the vehicle. In an example embodiment, the signals are transmitted over an interval of time (e.g., during which the vehicle changes its location in relation to one or more devices that receive the signals).

In example embodiments, one or more of the communications device(s) 204 is configured to transmit the signals to one or more participatory elements of a monitoring system (e.g., a system for monitoring and managing transportation infrastructure and locations of vehicles therein). For example, and referring to FIG. 1, the communications device 204 is included as a part, a component, or a peripheral of the electronic tracking device 104 and is configured to transmit the signals, either directly or indirectly (e.g., via the network 106 or the satellites 108a, 108b, and 108c), to the processing center 110 and/or one or more of the system interfacing elements 112. In example embodiments, the processing center 110 and/or other participatory elements of a monitoring system receive or are provided with the signals and/or information (e.g., signals and/or information received over an interval of time). In example embodiments, the processing center 110 and/or other participatory elements of a monitoring system store the signals and/or information, utilize the signals and/or information to update one or more databases, and/or process the signals and/or information.

Referring again to FIG. 2, in an example embodiment, the electronic tracking device 200 is configured to receive and respond to interrupts and/or commands from one or more of: authorized or approved sources and/or devices (e.g., law enforcement agencies, police and other authorized transmitter devices, blood alcohol sensors, one or more departments of motor vehicles, parking and/or traffic enforcement agencies, operators and users of a system for monitoring and managing transportation infrastructure and locations of vehicles therein, a person or an entity authorized or approved to receive or collect funds, an owner or a registered owner of the vehicle, a person or persons authorized or approved by the owner and/or the registered owner of the vehicle, lienholders, insurance companies, a processor or controller of or in communication with the electronic tracking device 200), biometric data acquisition devices, user-input mechanisms (e.g., on-board touch screen, mobile telephone, smartphone, or personal communication device (PCD) of the registered owner of the vehicle, emergency call devices), RFID transmitters, speed camera transmitters, and parking meters.

In example embodiments, and referring also to FIG. 1, one or more of the transmitter(s) 210, the data acquisition device(s) 212, and the user interface(s) and/or other input mechanism(s) 214 are included among the system interfacing elements 112 (FIG. 1). For example, the system interfacing elements 112 can include a speed camera or other image capture device configured to read a code 120 (e.g., a bar code) provided on the vehicle 102 and to utilize information or data obtained from reading the code 120 to generate (or facilitate the generation of) an interrupt and/or command. In an example embodiment, the information or data is obtained (directly) by reading the code 120. In another example embodiment, the information or data used by a system interfacing element 112 to determine if an interrupt and/or command should be generated is provided at least in part by another source (e.g., the processing center 110) or device. For example, the speed camera transmits or causes another device to transmit an interrupt and/or command in response to a determination or information indicating that the vehicle 102 is or was traveling at an unlawful, inappropriate, or excessive speed. In this example, a speed camera transmitter can uplink the interrupt and/or command (e.g., to the processing center 110) or directly transmit the interrupt and/or command (e.g., to a receiver or other communications device of the electronic tracking device 200). In example embodiments, a speed camera (or other transmitter-equipped system interfacing element 112) can also transmit an interrupt and/or command, as well as other information or data, either directly or indirectly, to other participatory elements of a monitoring system.

The code 120 can be provided in the form of numbers, letters, characters, symbols, and/or other indicia, whether visible or otherwise (e.g., code that is not revealed by visible light, but rather by infrared). The code 120 can be human-readable, machine-readable, or both. In example embodiments, the code 120 is provided on the vehicle 102 in the form of a material such as paint (e.g., in conjunction with applying paint to the vehicle during its manufacture) that is readable by a speed camera or other image capture device independent of whether the electronic tracking device 104 is present or operational. Thus, the code 120 can serve as an alternative or supplemental means for providing vehicle identification information, i.e., means that can be utilized when the electronic tracking device 200 malfunctions or ceases normal operation (i.e., transmitting the signals), or if the vehicle has not been provided with an electronic tracking device, or if the electronic tracking device has been removed from the vehicle.

In example embodiments, the interrupts and/or commands facilitate, control, or initiate (e.g., in response to commands or instructions executed by the processor 206 and/or by a processor/controller accessible to and/or in communication with the electronic tracking device 200) one or more of, for example: modifying the information transmitted or adding additional information to the signals transmitted by the electronic tracking device; providing information and/or notifications to authorized operators and users of a system for monitoring and managing transportation infrastructure and locations of vehicles therein; controlling an interactive user interface, a graphical user interface, or a display inside the vehicle, on a mobile communications device (e.g., a mobile telephone, a smartphone, or other PCD configured to facilitate wireless communications), and/or at a remote location to provide one or more of information, instructions, a notification, a warning, and a prompt; transferring funds from an account associated with one or more of the vehicle, an owner, a driver, a custodian, or a passenger of the vehicle, a person, an animal, an object within, secured to, or transported by the vehicle, and a person, an entity, an object, a status, a condition, an event, an indication, or an interrupt associated with the vehicle to one or more other accounts; and issuing a ticket, citation, warning or other communication. It should be understood that the personal computing devices described herein are presented as examples of devices capable of generating interfaces (e.g., interactive displays) in response to commands received and/or resources accessed via a network (or other communication means) and that the scope of the invention(s) includes implementations in which other devices are alternatively or additionally utilized to provide interfaces in relation to or otherwise implement the technologies and/or methodologies described herein.

The process of modifying the information transmitted or adding additional information to the signals transmitted by the electronic tracking device includes, by way of example, changing information associated with the vehicle or a status of a person or object associated with the vehicle, or adding biometric information (e.g., biometric information identifying in association with the vehicle an unauthorized driver of the vehicle or a wanted criminal), RFID information (e.g., RFID information received by the electronic tracking device 200 identifying stolen goods on board the vehicle), or emergency call information (e.g., information constituting an emergency call or a call for help received from an approved/authorized transmitter, beacon, or the like) to the signals. In an example embodiment, the electronic tracking device 200 includes or is operatively coupled or connected to a data acquisition device 212 (e.g., a fingerprint reader, retinal scanner, or blood alcohol sensor), which can be configured to require an input from the driver (e.g., as a prerequisite to enabling operation of the vehicle), as well as an input from some or all of the passengers (e.g., associating inputs provided at one or more data acquisition device(s) 212 with particular seats in the vehicle). Detection of a passenger who has not provided an input via a data acquisition device 212 can be accomplished utilizing weight sensors in the seats to provide this additional input to the electronic tracking device 200.

The process of providing information and/or notifications to authorized operators and users of a system for monitoring and managing transportation infrastructure and locations of vehicles therein includes, by way of example, providing information and/or notifications relating to vehicle registration (e.g., information about a vehicle registration process, a notification of a registration renewal deadline, a notification to a law enforcement agency that a vehicle registered to a felon or some other category or type of criminal has been identified within a particular area or region), a driver's license (e.g., a notification of a deadline for renewing a driver's license), an insurance policy (e.g., a notification of a deadline for renewing an automobile insurance policy), and/or a location (e.g., a tracked location) of a stolen vehicle (thereby assisting law enforcement agencies in tracking stolen vehicles and reducing the overall cost to insurance companies and the overall insurance rate to the general public.) The authorized operators and users include one or more of, for example: a law enforcement agency, a government agency (e.g., one or more departments of motor vehicles), a state, a county, a city, a town, or a municipality, a company or other private-sector entity or organization (e.g., a lienholder, an insurance company), an individual or a group (e.g., security guards/personnel, private investigators, deputized individuals, groups of citizens) provided with an authorized or approved device (e.g., proprietary equipment), an owner or a registered owner of the vehicle, and a person authorized or approved by the owner and/or the registered owner (e.g., family members, employees).

The process of controlling an interactive user interface, a graphical user interface, or a display inside the vehicle, on a mobile communications device, and/or at a remote location to provide one or more of information, instructions, a notification, a warning, and a prompt includes, by way of example, controlling an interactive user interface, a graphical user interface, or a display to provide information to a driver that his or her vehicle is approaching a checkpoint, an accident, or a potential hazard. For example, the interface or display is controlled to provide the information on a map (e.g., updated utilizing GPS data) that includes visual representations of, or icons representing, police, DUI, and/or other checkpoints in an area or region that the vehicle is moving through. In another example embodiment, the interface or display is controlled to provide information to a government agency (e.g., United States Secret Service), a law enforcement agency (e.g., state or city police), and/or a security organization (e.g., private security personnel) that a vehicle (e.g., registered to a felon, criminal, or other person or entity of interest or concern) has been identified or information relating to a detected or reported location and/or movement of the vehicle. For example, the interface or display is controlled to provide the information on a map (or other representation of an area or region) that includes visual representations of, or icons representing, detected vehicles and/or information associated with each of the vehicles (e.g., information downloaded from a database maintained at the processing center 110).

In another example embodiment, the interface or display (e.g., generated inside the vehicle and/or on a mobile communications device associated with the owner or registered owner of the vehicle) is controlled to provide a notification relating to registration of the vehicle, e.g., a message notifying a person who has been in California for 20 days that they need to register their vehicle if they now reside in California. Information as to whether a person has accepted gainful employment in California, claimed a homeowner's exemption in California, has rented or leased a residence in California, has acquired a California driver's license or registered to vote, enrolled in an institute of higher learning as a California resident, or enrolled their dependents in school (K-12) can also be taken into consideration in controlling the interface or display. For example, nonresident military personnel stationed in California and their spouses may operate their vehicles with valid out-of-state license plates from their home state of the state where the military person was last stationed. In example embodiments, one or more departments of motor vehicles (DMVs) are participants in a monitoring system that shares and/or aggregates information as between the DMV(s) and other authorized or approved participants (e.g., lienholders). Technically, a lienholder is the co-owner of a vehicle. If the registered owner fails to pay the lienholder, the location of the vehicle can be established in assisting the lienholder repossess the vehicle. This will reduce the cost of repossession to many financial institutions. To this end, in another example embodiment, the interface or display (e.g., generated at a remote location in relation to the vehicle) is controlled to provide a notification (e.g., to a lienholder) pertaining to one or more of, for example: names and addresses of the registered owner of the vehicle, the legal owner of the vehicle, and interested parties in relation to the vehicle (e.g., from DMV vehicle history records, which are incorporated into one or more databases maintained and managed, for example, by one or more monitoring system participants).

In another example embodiment, the interface or display (e.g., generated inside the vehicle and/or on a mobile communications device associated with the owner or registered owner of the vehicle) is controlled to provide a warning relating to a location and/or movement of the vehicle. For example, the interface or display (and, optionally, also a speaker or other sound generating device) is controlled to provide a visual representation of the warning (e.g., a text message, such as: “You are traveling at an excessive speed. This is a courtesy warning. Next time, you will receive a citation and fine, and possibly additional penalties, impounding of your vehicle, and/or suspension or revocation of your driver's license as may be appropriate or required under the law.”)

In another example embodiment, the interface or display (e.g., generated inside the vehicle, on a mobile communications device associated with the owner or registered owner of the vehicle, and/or at a remote location in relation to the vehicle) is controlled to provide a prompt relating to the vehicle. For example, the interface or display (and, optionally, also a speaker or other sound generating device) is controlled to provide a visual representation of the prompt (e.g., a user interface presenting a message field or other visual representation of a prompt to renew and/or authorize a transfer of funds for renewal of a vehicle registration, a driver's license, and/or automobile insurance).

The process of transferring funds from an account associated with one or more of the vehicle, an owner, a driver, a custodian, or a passenger of the vehicle, a person, an animal, an object within, secured to, or transported by the vehicle, and a person, an entity, an object, a status, a condition, an event, an indication, or an interrupt associated with the vehicle to one or more other accounts includes, by way of example, transferring funds from an account associated with a renter of the vehicle (e.g., if a moving violation involving the vehicle is detected or determined to have occurred while the renter was driving the vehicle) or a passenger of the vehicle identified from biometric data (e.g., an obligor parent in child support arrears identified, for example, by checking identified passengers or other persons in the vehicle to determine if they are included in a “deadbeat parents” database), or transferring funds from the account to one or more accounts associated with multiple departments of motor vehicles (e.g., revenue splitting between California and Michigan DMVs). The one or more other accounts are associated with one or more of, for example: an entity authorized to receive or collect funds in relation to a parking or moving violation associated with the vehicle, a government agency (e.g., a DMV), a state, a county, a city, a town, a municipality, a court, a lienholder, and an insurance company.

The process of issuing a ticket, citation, warning or other communication includes, by way of example, issuing a ticket, citation, warning or other communication in relation to a parking or moving violation associated with the vehicle). For example, the VIN of the vehicle is transmitted with a computer or processor generates the citation for a particular violation associated with the vehicle. In the case of speeding violations, vehicle speed can be determined using GPS data only, radar reports of the speed of the vehicle associated with a particular VIN, or utilizing GPS data in conjunction with radar speed measurements.

The technologies and methods described herein can be implemented, by way of example, utilizing one or more websites, user interfaces, and/or applications. In an example embodiment, referring again to FIG. 1, the processing center 110 can perform the functions of, provide, or facilitate a service host (e.g., implemented in the form of servers, processors, or the like operating under the control of software and/or other sources of commands or inputs) configured, for example, to utilize a system application or other platform to facilitate vehicle associated monitoring and/or other activities or tasks, for example, by hosting a website accessible by system participants and/or users via the network 106.

In example embodiments, technologies and methods for monitoring and managing transportation infrastructure and locations of vehicles therein are implemented via a website (and/or one or more other resources accessible via a network or otherwise).

In example embodiments, technologies and methods for improving a vehicle registration process are implemented as an addition and/or an improvement to an existing website such as the official website of California Department of Motor Vehicles (dmv.ca.gov), The Los Angeles Police Department (www.lapdonline.org), or The Federal Bureau of Investigation (www.fbi.gov). In an example embodiment, one or more interfaces are generated utilizing a custom plug-in system application which functions as an extension and overlay to an existing system application or other platform that facilitates, for example, on-line vehicle registration renewal and/or driver's license renewal. It should be understood that the user interfaces described herein can be implemented or provided utilizing a website, an addition and/or an improvement to an existing website, or a resource other than a website, and independent of whether the resource is directly accessible by the user. Furthermore, resources can be distributed with respect to their physical locations and can be controlled, individually or as groups (e.g., shared resources), by one or more service hosts and/or system participants.

In an example “Vehicle Digital Registration” technology and/or methodology, each manufacturer of a motor vehicle is required, encouraged, and/or incentivized to install an electronic tracking device or other transmission device that communicates (e.g., continually transmits) information including vehicle identification information (e.g., the VIN of the vehicle) to a satellite and/or a sensor which establish the VIN of a vehicle to a satellite. For example, a DMV or other government agency can make the installation of a transmitter/sensor a requirement (e.g., a required step in the vehicle registration process) and mandatory in new vehicles as well as used vehicles.

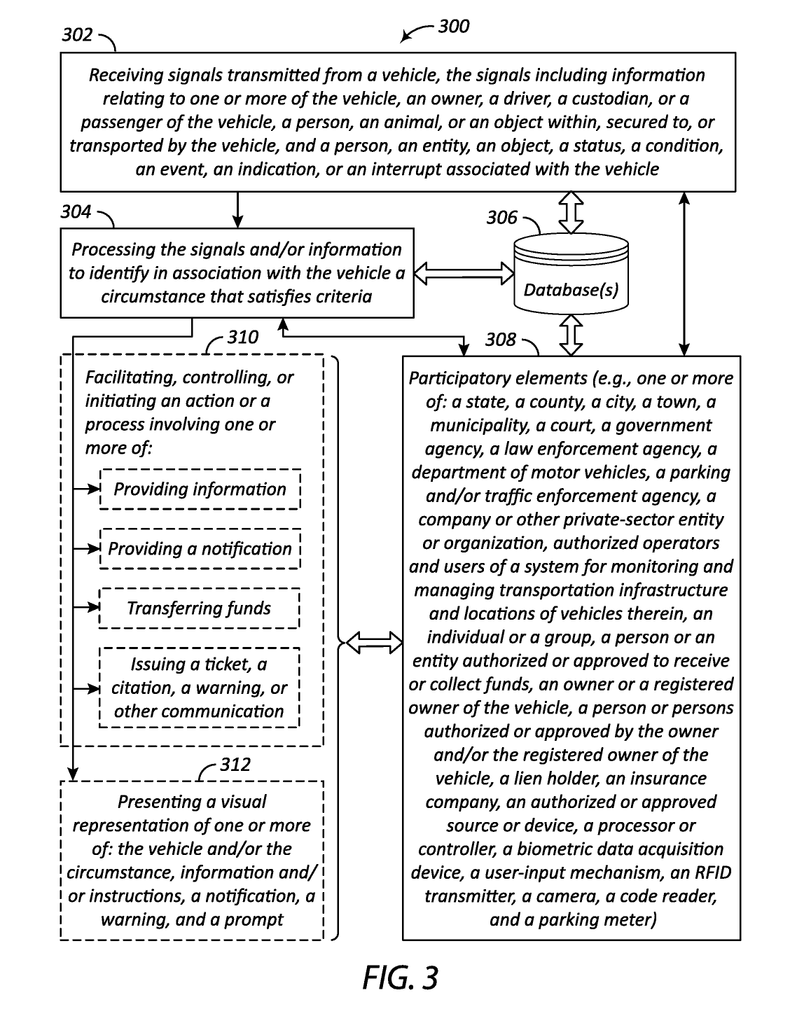

FIG. 3 shows an example implementation of a method 300 for monitoring and managing transportation infrastructure and locations of vehicles therein. At 302, signals transmitted from a vehicle are received (e.g., and referring also to FIG. 1, by one or more of the network 106, the satellites 108a, 108b, and 108c, the processing center 110, and the system interfacing elements 112). The signals include information relating to (e.g., identifying) one or more of, for example: the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle. In an example embodiment, the signals are received over an interval of time.

At 304, the signals and/or information are processed to identify in association with the vehicle a circumstance that satisfies (predetermined or other) criteria. The signals and/or information are processed, for example, by the processing center 110 and/or one or more of the system interfacing elements 112 (e.g., operators, users, and/or devices involved in or facilitating a system for monitoring and managing transportation infrastructure and locations of vehicles therein). In example embodiments, the signals and/or information are processed at least in part by participatory elements 308. By way of example, the participatory elements 308 include one or more of: a state, a county, a city, a town, a municipality, a court, a government agency, a law enforcement agency, a department of motor vehicles, a parking and/or traffic enforcement agency, a company or other private-sector entity or organization, authorized operators and users of a system for monitoring and managing transportation infrastructure and locations of vehicles therein, an individual or a group, a person or an entity authorized or approved to receive or collect funds, an owner or a registered owner of the vehicle, a person or persons authorized or approved by the owner and/or the registered owner of the vehicle, a lienholder, an insurance company, an authorized or approved source or device, a processor or controller, a biometric data acquisition device, a user-input mechanism, an RFID transmitter, a camera, a code reader, and a parking meter. In example embodiments, information, data, and/or programs stored in one or more database(s) 306 is utilized in processing the signals and/or information. The database(s) 306 include one or more of, for example, a law enforcement database, a DMV database, an insurance database, and a lienholder database. It should be understood that the database(s) 306 can include additional database(s) pertaining, for example, to other types of information and/or data as described herein.

In an example embodiment, the circumstance is an identification, a determination, and/or a prediction of one or more of a parking violation and a moving violation associated with one or more of the vehicle, an owner, a driver, a custodian, or a passenger of the vehicle, and a person within or transported by the vehicle.

In another example embodiment, the circumstance is an identification, a determination, and/or a prediction that one or more of a registration, a driver's license, and an insurance policy associated with one or more of the vehicle, an owner, a driver, a custodian, or a passenger of the vehicle, and a person within or transported by the vehicle is, or will be, expired, out-of-state, canceled, revoked, and/or suspended.

In another example embodiment, the circumstance is an identification, a determination, and/or a prediction that one or more of an account, a tax, an assessment, a charge, a surcharge, a fee, a fine, and a penalty associated with one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle is, or will be, late, overdue, unpaid, delinquent, and/or in default (e.g., a deadbeat parent passenger of the vehicle who is late in paying child support; valuables, such as jewelry tracked with RFID-based technology, that were purchased pursuant to an installment payment plan now in default).

In another example embodiment, the circumstance is a crime, reported, detected or suspected criminal activity, or an identification, a determination, and/or a prediction of a crime or criminal activity associated with one or more of the vehicle, an owner, a driver, a custodian, or a passenger of the vehicle, a person, an animal, or an object within, secured to, or transported by the vehicle, and a person (e.g., human trafficking/smuggling), an entity, an object (e.g., stolen goods), a status, a condition, an event, an indication, or an interrupt associated with the vehicle.

In another example embodiment, the circumstance is an identification, a determination, and/or a prediction of a status associated with one or more of the vehicle (e.g., stolen), an owner, a driver, a custodian, or a passenger of the vehicle, a person, an animal, or an object within, secured to, or transported by the vehicle, and a person (e.g., felon, parolee, registered sex offender, child molester), an entity, an object, a condition, an event, an indication, or an interrupt associated with the vehicle.

In another example embodiment, the circumstance is an identification, a determination, and/or a prediction of one or more of a condition (e.g., illegal, non-exempted, excessive or increasing levels of emissions, or greenhouse gases, that are being generated by the vehicle; intoxication/impairment of the driver of the vehicle), an indication (e.g., vehicle transmitter malfunctioning, attempt was made to disable), and an interrupt associated with one or more of the vehicle, an owner, a driver, a custodian, or a passenger of the vehicle, a person, an animal, or an object within, secured to, or transported by the vehicle, a person, an entity, an object, a status, or an event associated with the vehicle, and a location, an area, a region, or an environment within which the vehicle is located, or that the vehicle is approaching or departing from. Examples of interrupts include: an alert (e.g., child abduction/Amber Alert, hazardous materials alert/Hazmat alert), an emergency call (e.g., SOS, 911, body function/vital signs monitor automatically generating emergency call, for example, in response to cardiac arrest), an alarm (e.g., silent alarm triggered by an undercover peace officer inside the vehicle).

In another example embodiment, the circumstance is an event (e.g., a presidential motorcade) for or during which a location of the vehicle or a person, an animal, or an object within, secured to, or transported by the vehicle presents or potentially raises a concern in relation to the event.

In another example embodiment, the circumstance is an identification, a determination, and/or a prediction that a location (e.g., a tracked location) of the vehicle is within, approaching, or departing from an area, a region, or an environment designated as prohibited, unlicensed, limited, restricted, or cautionary access in relation to one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle.

In another example embodiment, the circumstance is an identification, a determination, and/or a prediction that a location (e.g., a tracked location) of the vehicle is outside, departing from, or returning to an area, a region, or an environment designated as allowed, permitted, licensed, unlimited, unrestricted, or safe access in relation to one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle.

At 310, an action or a process is facilitated, controlled, or initiated (e.g., by one or more of the participatory elements 308). The action or process involves one or more of, for example: providing information, providing a notification, transferring funds, and issuing a ticket, citation, warning or other communication. In an example embodiment, a method for monitoring and managing transportation infrastructure and locations of vehicles therein includes processing the signals and/or the information to identify in association with the vehicle a circumstance that satisfies criteria for facilitating, controlling, or initiating an action or a process involving one or more of providing information, providing a notification, transferring funds, and issuing a ticket, a citation, a warning, or other communication.

An action or a process involving providing information includes, by way of example, providing information pertaining to one or more of the vehicle, an owner, a driver, a custodian, or a passenger of the vehicle, a person, an animal, or an object within, secured to, or transported by the vehicle, a person, an entity, an object, a status, a condition, an event, an indication, or an interrupt associated with the vehicle, the circumstance, and a location, an area, a region, or an environment within which the vehicle is located, or that the vehicle is approaching or departing from, to one of more of, for example: a law enforcement agency, a government agency, a state, a county, a city, a town, or a municipality, a company or other private-sector entity or organization, an individual or a group provided with an authorized or approved device, an owner or a registered owner of the vehicle, and a person authorized or approved by the owner and/or the registered owner.

With respect to an action or a process involving providing a notification, the notification pertains to one or more of, for example: a parking violation and/or a moving violation associated with one or more of the vehicle, an owner, a driver, a custodian, or a passenger of the vehicle, and a person within or transported by the vehicle; a crime, criminal activity, illegal action, prohibited substance, criminal record or notice and/or conviction associated with one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle; a location and/or a movement of the vehicle; locations and/or movements of one or more vehicles associated with a person, persons, entity, object, group, organization, event, enterprise, and/or circumstance; an event for or during which a location of the vehicle or a person, an animal, or an object within, secured to, or transported by the vehicle presents or potentially raises a concern in relation to the event; an area, a region, or an environment designated as prohibited, unlicensed, limited, restricted, or cautionary access in relation to one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle; an area, a region, or an environment designated as allowed, permitted, licensed, unlimited, unrestricted, or safe access in relation to one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle; a registration, a driver's license, and/or an insurance policy associated with one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle; vehicle registration requirements for new residents of the state; and information and/or updates to information in a DMV or other database.

An action or a process involving transferring funds includes, by way of example, transferring funds from an account associated with one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle to one or more other accounts (e.g., revenue splitting between California and Michigan DMVs). By way of example, the one or more other accounts are associated with one or more of: an entity authorized to receive or collect funds in relation to a parking or moving violation associated with the vehicle, a state agency (e.g., a DMV), a city, a municipality, a court, a lienholder, and an insurance company.

With respect to an action or a process involving issuing a ticket, a citation, a warning, or other communication, in an example embodiment, the ticket, citation, warning, or other communication is electronically issued and/or automatically transmitted (e.g., to the person ticketed/cited/warned and/or to other interested, appropriate, or designated recipients such as, for example, a parole officer, a parent/guardian, or a superior officer). In an example embodiment, a ticket, a citation, a warning, or other communication in relation to a parking or moving violation associated with the vehicle is automatically generated and electronically transmitted (e.g., at a time deemed appropriate depending upon the nature and/or circumstances of the violation).

In an example embodiment, a citation is automatically generated and transmitted (e.g., when it is detected or otherwise determined that a vehicle is using public roads with an expired registration). To this end, the database(s) 306 can also include or facilitate access to information indicating whether a road is public or private. Thus, example methodologies and technologies described herein embody and/or provide an “Automatic Citation Tool” that can be utilized by law enforcement agencies or others to track and/or find vehicles that travel on roadways and/or use public streets with expired registrations or registrations soon to expire or in a renewal grace period. The “Automatic Citation Tool” described herein compares favorably, at least in terms of efficiency, to the traditional process of a parking enforcement officer or law officer visually inspecting the license tag of a license plate in order to identify vehicles that are using the public roadways with expired registrations.

In another example embodiment, an account, person, or entity associated with a vehicle is automatically billed when it is detected or otherwise determined that the vehicle is not properly registered. For example, a bill is automatically generated after a vehicle from another state (or country) has been within the border of a state for a period of time (e.g., a minimum number of days) triggering a requirement of vehicle registration in that state. Thus, example methodologies and technologies described herein embody and/or provide an “Automatic Registration Billing Tool” that can be utilized by a DMV to help increase the amount of vehicle registration revenues received and the speed with which they are received. Moreover, the “Automatic Registration Billing Tool” described herein stands to dissuade the pervasive practice—often perpetrated by the owners of expensive vehicles—of purchasing vehicles in another state, which may have lower or no vehicle registration fees, but using the vehicle primarily in some other state (e.g., purchasing and registering a vehicle in Nevada, while garaging and using the vehicle in California). In another embodiment, an “Automatic Registration Billing Tool” automatically determines (e.g., based on monitored locations of the vehicle) circumstances when a prorated, shared, or other distribution of vehicle registration fees (or other vehicle-related fees or revenues) is warranted as between multiple states or other jurisdictions.

Example methodologies and technologies described herein present, or facilitate a presentation of, visual representations pertaining to a vehicle, a circumstance, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle, information, and/or notifications. Example implementations utilize a network and/or communications links and one or more interfaces and/or displays are to present the visual representations.

At 312, a visual representation is presented (e.g., to one or more of the participatory elements 308). By way of example, the visual representation presented is a visual representation of one or more of: the vehicle and/or the circumstance, information and/or instructions, a notification, a warning, and a prompt. In an example embodiment, a method for monitoring and managing transportation infrastructure and locations of vehicles therein includes presenting a visual representation of one or more of: the vehicle and/or the circumstance, information and/or instructions, a notification, a warning, and a prompt.

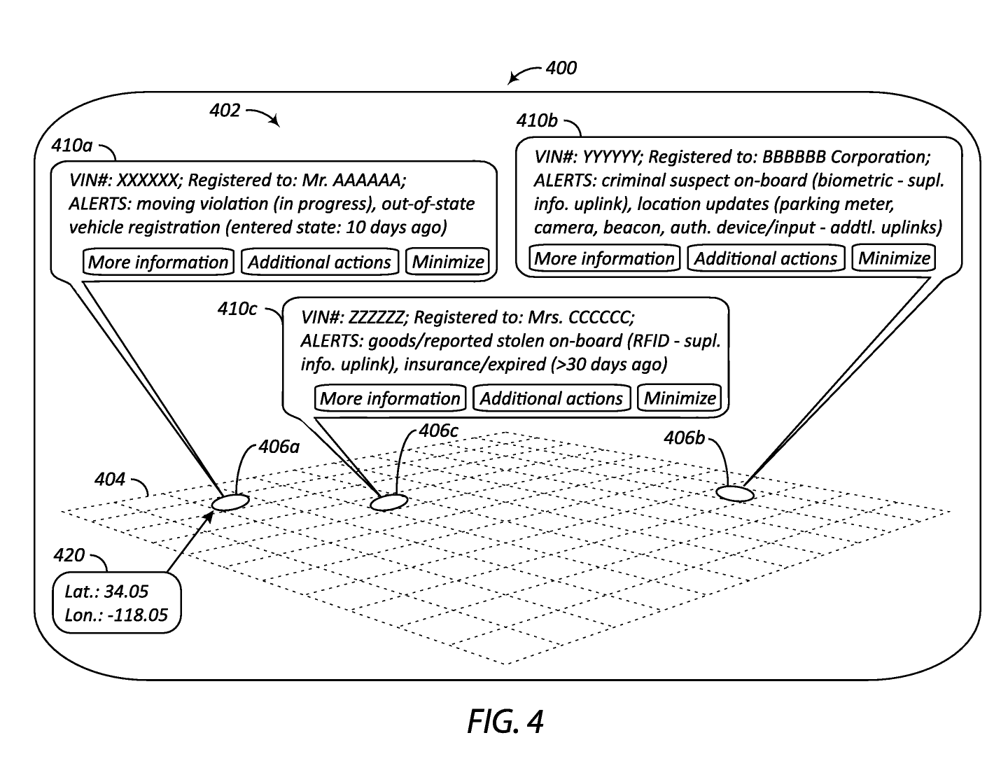

FIG. 4 shows an example interactive interface 400 presenting a visual representation 402 of a region 404, vehicles 406a, 406b, and 406c within the region, and information associated with the vehicles. In this example, interface portions 410a, 410b, and 410c (of the interface 400) are controlled to provide information associated with the vehicles 406a, 406b, and 406c, respectively. Within each of the interface portions 410a, 410b, and 410c, sub-portions denoted “More information”, “Additional actions”, and “Minimize” are actuated, for example, by touching a location of the interface 400 bound by one of the sub-portions. For example, in response to selections and/or inputs provided at a menu or interface facilitating “Additional actions”, a display portion 420 is generated to present latitude and longitude information for a particular vehicle. In this example, the interface portion 410a provides the following information about and/or associated with the vehicle 406a: “VIN#: XXXXXX; Registered to: Mr. AAAAAA. ALERTS: moving violation (in progress), out-of-state vehicle registration (entered state: 10 days ago)”. In this example, the interface portion 410b provides the following information about and/or associated with the vehicle 406b: “VIN#: YYYYYY; Registered to: BBBBBB Corporation; ALERTS: criminal suspect on-board (biometric—supl. info. uplink), location updates (parking meter, camera, beacon, auth. device/input—addtl. uplinks)”. In this example, the interface portion 410c provides the following information about and/or associated with the vehicle 406c: “VIN#: ZZZZZZ; Registered to: Mrs. CCCCCC; ALERTS: goods/reported stolen on-board (RFID—supl. info. uplink), insurance/expired (>30 days ago)”.

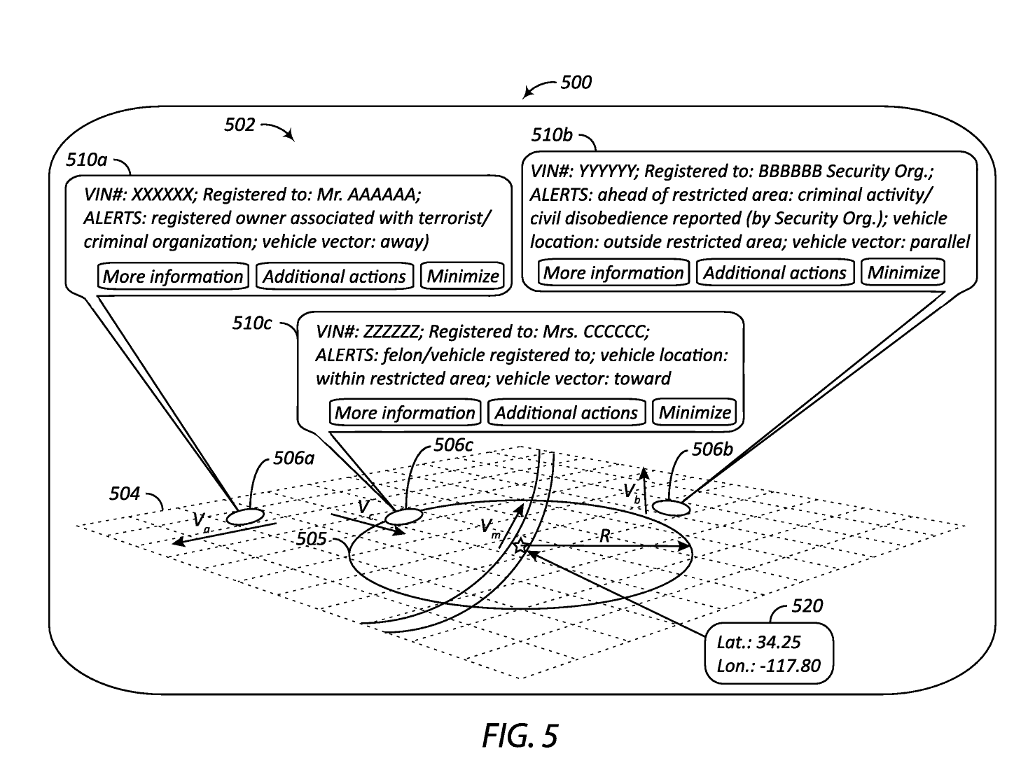

FIG. 5 shows another example interactive interface 500 presenting a visual representation 502 of a region 504, a restricted area 505 within the region, vehicles 506a, 506b, and 506c within the region, and information associated with the vehicles. In this example, interface portions 510a, 510b, and 510c (of the interface 500) are controlled to provide information associated with the vehicles 506a, 506b, and 506c, respectively. Within each of the interface portions 510a, 510b, and 510c, sub-portions denoted “More information”, “Additional actions”, and “Minimize” are actuated, for example, by touching a location of the interface 500 bound by one of the sub-portions. For example, in response to selections and/or inputs provided at a menu or interface facilitating “Additional actions”, a display portion 520 is generated to present latitude and longitude information for a particular vehicle. In this example, the interface portion 510a provides the following information about and/or associated with the vehicle 506a: “VIN#: XXXXXX; Registered to: Mr. AAAAAA; ALERTS: registered owner associated with terrorist/criminal organization; vehicle vector: away)”. In this example, the interface portion 510b provides the following information about and/or associated with the vehicle 506b: “VIN#: YYYYYY; Registered to: BBBBBB Security Org.; ALERTS: ahead of restricted area: criminal activity/civil disobedience reported (by Security Org.); vehicle location: outside restricted area; vehicle vector: parallel”. In this example, the interface portion 510c provides the following information about and/or associated with the vehicle 506c: “VIN#: ZZZZZZ; Registered to: Mrs. CCCCCC; ALERTS: felon/vehicle registered to; vehicle location: within restricted area; vehicle vector: toward”.

Example methodologies and technologies described herein present, or facilitate a presentation of, visual representations of vehicles detected within a specified or otherwise determined area or region. In the example interface 500, a restricted area 505 is an area or region defined by a circular boundary existing at a radius R about a center point located at the “star” icon. In this example, the center point of the restricted area 505 moves with (e.g., tracks using GPS data) the location of the “star” icon (which, by way of example, serves as a visual representation of a vehicle in a presidential motorcade). An area or region can be specified or determined in various ways, resulting in boundaries that are circular, non-circular, square, rectangular, or other shapes. An area or region can be specified or determined such that it includes multiple portions (e.g., overlapping and/or non-overlapping portions), which can be stationary or fixed in relation to the region 504, move or reposition in relation to a location of a tracked vehicle, person, or object, or a combination of static and dynamically specified or determined portions (e.g., of a searched and/or monitored area or region).

The interface 500 is generated, for example, in response to a search request and includes visual representations presented in a user-friendly manner or other arrangement (e.g., appropriate for providing a law enforcement officer of other person with an arrangement of information optimized to permit reading of the most critical information first, for example, within each line of text presented). For example, if a law enforcement officer searches for all vehicles with a 5 block radius, the display 500 is controlled to present information about or associated with the detected vehicles (e.g., vehicle identification information, information about the registered owners of the vehicles, etc.) Search request criteria can be changed to accommodate different crime prevention scenarios. For example, the radius R can be set to 1/10 mile to identify vehicles located a short distance from a bank robbery, theft, or other crime in progress. In an example embodiment, search results are generated based on search criteria/circumstance, and further filtered, if desired. In example embodiments, search results can be analyzed immediately and/or at a later time. The data can also be retroactively analyzed (e.g., in consideration of additional information and/or data from other sources or devices).

In an example embodiment, the display 500 is controlled to present information including, for example, updated and/or new information or inputs provided by authorized or approved sources or devices. Updated and/or new information or inputs used to control generation of a visual representation at the display 500 can be provided, for example, in response to an interrupt or other signal generated by an officer in the field, citizen, or other person who has observed or become aware of criminal activity/civil disobedience (e.g., in association with, for example, a location, a vehicle, a person, and/or a group). Updated and/or new information or inputs used to control generation of a visual representation at the display 500 can also be provided, for example, by a person with an image capture device (e.g., equipped with code reading software), independent of whether the image capture device is configured to facilitate wireless communications. For example, images captured by the device (e.g., an authorized or approved device) can be transferred through a wired connection, removable memory component, or otherwise to another computer or device that communicates the image data and/or associated information to a processing center. Updated and/or new information or inputs used to control generation of a visual representation at the display 500 can also be provided, for example, via a Bluetooth, Wi-Fi, or other wireless communications link. For example, persons participating in or conducting surveillance, neighborhood watch, and/or various other “citizen sentinel” activities (e.g., while sitting at a sidewalk café at which a Wi-Fi connection is available) can be provided with access to a secure website or other interface through which they can provide updated and/or new information or inputs that can be used to control generation of a visual representation at the display 500. In this regard, information associated with such persons can also be used to assess the credibility or likely significance, importance, or criticality of information or inputs submitted by said persons.

Referring again to FIG. 3, an example method for monitoring and managing transportation infrastructure and locations of vehicles therein further includes adding information pertaining to one or more of the vehicle, an owner, a driver, a custodian, or a passenger of the vehicle, a person, an animal, or an object within, secured to, or transported by the vehicle, a person, an entity, an object, a status, a condition, an event, an indication, or an interrupt associated with the vehicle, the circumstance, and a location, an area, a region, or an environment within which the vehicle is located, or that the vehicle is approaching or departing from, to a database and/or using the information to update a database. In another example embodiment, the method for monitoring and managing transportation infrastructure and locations of vehicles therein further includes adding to or modifying the information, the circumstance, and/or the criteria in response to an input or inputs provided by one or more of, for example: a state, a county, a city, a town, or a municipality, a court, a government agency, a law enforcement agency, a department of motor vehicles, a parking and/or traffic enforcement agency, a company or other private-sector entity or organization, authorized operators and users of a system for monitoring and managing transportation infrastructure and locations of vehicles therein, an individual or a group provided with one or more authorized or approved devices, the use of which results in input(s) being provided, a person or an entity authorized or approved to receive or collect funds in relation to a parking or moving violation associated with the vehicle, an owner or a registered owner of the vehicle, a person or persons authorized or approved by the owner and/or the registered owner of the vehicle, a lienholder, an insurance company, an authorized or approved source (e.g., of inputs and/or data) or device (e.g., law enforcement agency transmitter devices and other authorized or approved transmitters, beacons, or communications devices), a processor or controller (e.g., of or in communication with an electronic tracking device monitoring the location of the vehicle), a biometric data acquisition device, a user-input mechanism (e.g., on-board touch screen, mobile communications device, and/or PCD of the registered owner of vehicle, emergency call devices), an RFID transmitter, a camera (e.g., a speed camera or other image capture device), a code reader (e.g., a device that reads a bar code or other code on the vehicle), and a parking meter (e.g., a device configured to monitor and manage usage of a parking space and to receive information and/or other inputs in association with a vehicle).

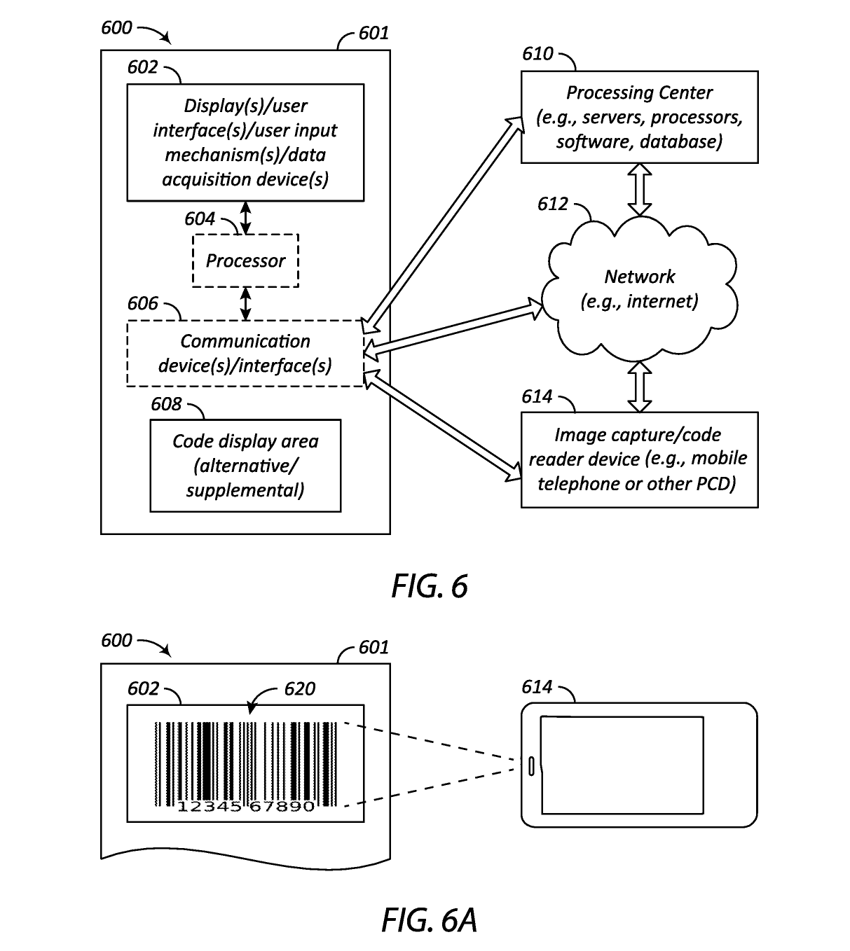

FIG. 6 shows an example apparatus 600 for monitoring and managing usage of a parking space. In an example embodiment, the apparatus 600 includes a parking meter 601 that facilitates providing information including a parking meter start time, a parking meter stop time, and an association between the parking meter and an account, and initiates or requests a transaction in which the account is charged (or debited) depending upon an amount of time passing between the start time and the stop time.

In an example embodiment, the association is between a uniquely identified parking meter and an account and is established utilizing a code. In an example embodiment, the association is established by a device that captures an image of the code and is configured with or utilizes or accesses code reader software that processes the image to read the code.

Referring again to FIG. 6, the parking meter 601 includes display(s)/user interface(s)/user input mechanism(s)/data acquisition device(s) 602, a processor 604, communication device(s)/interface(s) 606, and a code display area (alternative/supplemental) 608 configured as shown. In this example embodiment, the association is established utilizing a code provided on or generated by the parking meter 601. To this end, and referring also to FIG. 6A, an image capture/code reader device 614 (e.g., a mobile telephone, a smartphone, or a PCD) is utilized to capture an image of a code 620 (which is depicted, in this example, as a bar code) provided on or generated by the parking meter apparatus. In this example embodiment, the parking meter 601 is configured with (or utilizes or accesses) code generator software to generate the code 620 presented at the display 602. The code 620 can be provided in the form of numbers, letters, characters, symbols, and/or other indicia, whether visible or otherwise (e.g., code that is not revealed by visible light, but rather by infrared). The code 620 can be human-readable, machine-readable, or both. In an example embodiment, the code 620 is presented on the display 602 and/or printed, embossed, or applied on an external portion 608 of the parking meter 601 (e.g., provided on a metal plate secured to the parking meter 601).

The image capture/code reader device 614 can be provided, for example, in the form of a mobile telephone, a smartphone, or a PCD configured with a camera and with code reader software (and/or configured to utilize or access code reader software). Various software programs/products suitable for reading and/or decoding images of code captured by mobile telephones, smartphones, and PCDs are commercially available.

In this example embodiment, the communication device(s)/interface(s) 606 is configured to communicate with a processing center 610 (e.g., implemented in the form of servers, processors, or the like operating under the control of software and/or other sources of commands or inputs) directly and/or via a network 612 (e.g., the internet).

In an example embodiment, the parking meter 601 is configured to transmit or initiate a process of providing a communication to a device (e.g., the image capture/code reader device 614) that captures an image of the code 620. The communication can be provided directly from the parking meter 601 (e.g., generated by the processor 604), or from a remote processing location or center (e.g., in response to information provided to the processing center 610 by the parking meter 601). In an example embodiment, the communication includes a resource (e.g., URL) or other information that provides a user of the device with access to a receipt (e.g., PDF file/image) or other documentation or information relating to a transaction involving and/or usage of the parking meter.

In operation, the image capture/code reader device 614 is used to capture an image of the code 620 which, as previously discussed, can be presented at the processor-controlled display 602 and/or on the external display area 608. The external display area 608, as an alternative means for presenting the code 620, is useful for providing a lower cost parking meter (e.g., that is not configured to electronically present the code 620 at the display 602). The external display area 608, as a supplemental means for presenting the code 620, is useful for providing a parking meter that allows a user of the image capture/code reader device 614 to capture an image of the code 620 from a distance (e.g., while initially approaching the parking meter 601). In an example embodiment, the process of providing information including a parking meter start time, a parking meter stop time, and an association between the parking meter and an account can be performed utilizing the processor-controlled display 602 (at the parking meter 601), a user interface or other input mechanism separate from the parking meter 601 (e.g., presented on board the vehicle, at the image capture/code reader device 614, and/or at a mobile telephone, a smartphone, or a PCD of the registered owner of vehicle), or a combination thereof. For example, the process of providing information including a parking meter start time and an association between the parking meter and an account can be initiated by scanning or capturing an image of the code 620 presented at the external display area 608. In this example, the image capture/code reader device 614 captures an image of the code 620 and reads and/or decodes the captured image to establish the parking meter start time which is communicated to the parking meter 601 and/or the processing center 610 along with other information (e.g., stored on board or accessible to the image capture/code reader device 614) that can be used to establish the association between the parking meter and an account (e.g., an account associated with the owner of the image capture/code reader device 614). The association between the parking meter 601 and an account can be established at the parking meter start time or at another time. In an example embodiment, both the parking meter start and stop times are established utilizing the code 620 (e.g., by capturing an image of the code 620, reading and/or decoding the captured image, and communicating information including the start and stop times to the parking meter 601 and/or the processing center 610. In an example embodiment, the parking meter 601 is configured to establish the stop time utilizing an alternative code (e.g., provided to a person authenticated as being associated with the account and/or with a vehicle associated with the account). This accommodates a circumstance (occurring, for example, at a parking lot or parking garage) in which the driver has lost or cannot locate the image capture/code reader device 614, in response to which an attendant can provide the driver with an alternative code that the driver can use (e.g., keyed in or otherwise provided as an input at the display 602) to establish the parking meter stop time.

In an example embodiment, the parking meter 601 includes an interactive user interface, a graphical user interface, or display configured to provide a visual representation of one or more of, for example: an acknowledgement that the association, the start time and/or the stop time has been established, a prompt or request for additional information or user inputs (e.g., to associate a new/different/valid account with the generated code, to renew registration/license/insurance, to authorize transfer of funds for renewal of driver's license/vehicle registration/automobile insurance), information and/or instructions (e.g., hours when the parking space can be used, maximum amount of time permitted to park in the space/lot, how to obtain an alternative code if an authorized image capture/code reader device is lost, misplaced, or inoperative), a notification (e.g., a message notifying a person who has been in California for 20 days that they need to register their vehicle if they now reside in California), and a warning (e.g., a text message, such as: “When you were driving in [town, street] on [day] at approximately [time], you were traveling at an excessive speed. This is a courtesy warning. Next time, you will receive a citation and fine, and possibly additional penalties, impounding of your vehicle, and/or suspension or revocation of your driver's license as may be appropriate or required under the law.”)

In an example embodiment, the parking meter 601 (and/or a remote processing location/center in communication with the parking meter) is configured to access supplemental information identifying and/or in relation to a vehicle, person, entity and/or object associated with the account. In another example embodiment, the parking meter 601 (and/or a remote processing location/center in communication with the parking meter) is configured to provide or facilitate access to the supplemental information, parking meter usage information, and/or notifications relating to said information by one or more of, for example: an owner, an operator, or a vendor of the parking meter, a maintenance or service company, authorized operators and users of a system for monitoring and managing transportation infrastructure and locations of vehicles therein, a law enforcement agency, a parking enforcement agency, a government agency, a company or other private-sector entity or organization, a lienholder, an insurance company, authorized or approved individuals or groups, an owner or a registered owner of the vehicle, and a person or persons authorized or approved by the owner and/or the registered owner of the vehicle.

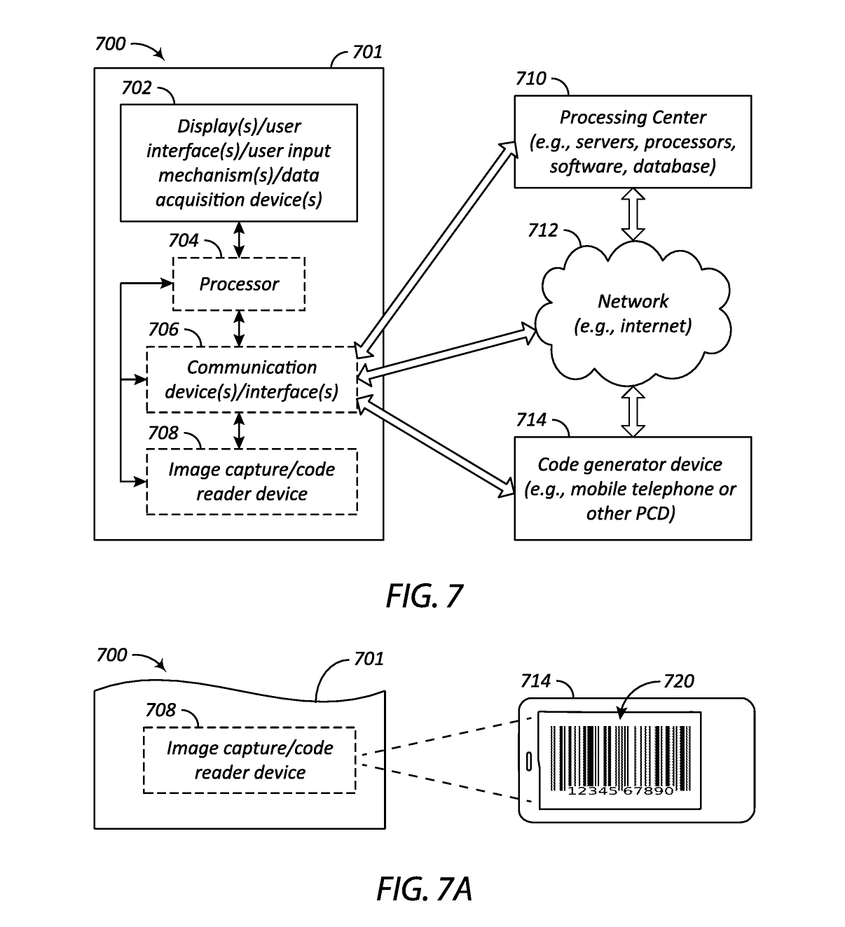

FIG. 7 shows another example apparatus 700 for monitoring and managing usage of a parking space. In an example embodiment, the apparatus 700 includes a parking meter 701 that facilitates providing information including a parking meter start time, a parking meter stop time, and an association between the parking meter and an account, and initiates or requests a transaction in which the account is charged (or debited) depending upon an amount of time passing between the start time and the stop time.

In an example embodiment, the association is between a uniquely identified parking meter and an account and is established utilizing a code. In an example embodiment, the association is established by a device that captures an image of the code and is configured with or utilizes or accesses code reader software that processes the image to read the code.

Referring again to FIG. 7, the parking meter 701 includes display(s)/user interface(s)/user input mechanism(s)/data acquisition device(s) 702, a processor 704, communication device(s)/interface(s) 706, and an image capture/code reader device 708 configured as shown. In this example embodiment, the association is established utilizing a code provided on or generated by a code generator device. To this end, and referring also to FIG. 7A, a code generator device 714 (e.g., a mobile telephone, a smartphone, or a PCD) is utilized to generate an image of a code 720 (which is depicted, in this example, as a bar code). In this example embodiment, the code generator device 714 is configured with (or utilizes or accesses) code generator software to generate the code 720 (e.g., presented at a display of a mobile telephone, a smartphone, or a PCD). The code 720 can be provided in the form of numbers, letters, characters, symbols, and/or other indicia, whether visible or otherwise (e.g., code that is not revealed by visible light, but rather by infrared). The code 720 can be human-readable, machine-readable, or both. In an example embodiment, the code 720 includes information (e.g., VIN) that uniquely identifies a vehicle.

The image capture/code reader device 708 can be provided, for example, in the form of a digital camera or other image capture device (of the parking meter 701) and code reader software run by (and/or utilized or accessible to) the processor 704. In an example embodiment, the processor 704 processes the image captured by the image capture/code reader device 708 to read the code 720. Various software programs/products suitable for reading and/or decoding images of code captured by digital cameras or other image capture devices are commercially available.

In this example embodiment, the communication device(s)/interface(s) 706 is configured to communicate with a processing center 710 (e.g., implemented in the form of servers, processors, or the like operating under the control of software and/or other sources of commands or inputs) directly and/or via a network 712 (e.g., the internet).

In an example embodiment, the parking meter 701 is configured to transmit or initiate a process of providing a communication to a device (e.g., the code generator device 714) that generates an image of the code 720. The communication can be provided directly from the parking meter 701 (e.g., generated by the processor 704), or from a remote processing location or center (e.g., in response to information provided to the processing center 710 by the parking meter 701). In an example embodiment, the communication includes a resource (e.g., URL) or other information that provides a user of the device with access to a receipt (e.g., PDF file/image) or other documentation or information relating to a transaction involving and/or usage of the parking meter.

In operation, the image capture/code reader device 708 is used to capture an image of the code 720 presented at a display of the code generator device 714. In an example embodiment, the process of providing information including a parking meter start time, a parking meter stop time, and an association between the parking meter and an account can be performed utilizing the processor-controlled display 702 (at the parking meter 701), a user interface or other input mechanism separate from the parking meter 701 (e.g., presented on board the vehicle, at the code generator device 714, and/or at a mobile communications device or PCD of the registered owner of vehicle), or a combination thereof. For example, the process of providing information including a parking meter start time and an association between the parking meter and an account can be initiated by scanning or capturing an image of the code 720 presented at a display of the code generator device 714. In this example, the image capture/code reader device 708 captures an image of the code 720 and reads and/or decodes the captured image to establish the parking meter start time which is communicated to the processor 704 (of parking meter 701) and/or the processing center 710 along with other information (e.g., provided by the code generator device 714) that can be used to establish the association between the parking meter and an account (e.g., an account associated with the owner of the code generator device 714). The association between the parking meter 701 and an account can be established at the parking meter start time or at another time. In an example embodiment, both the parking meter start and stop times are established utilizing the code 720 (e.g., by capturing an image of the code 720, reading and/or decoding the captured image, and communicating information including the start and stop times to the processor 704 (of parking meter 701) and/or the processing center 710. In an example embodiment, the parking meter 701 is configured to establish the stop time utilizing an alternative code (e.g., provided to a person authenticated as being associated with the account and/or with a vehicle associated with the account). This accommodates a circumstance (occurring, for example, at a parking lot or parking garage) in which the driver has lost or cannot locate the code generator device 714, in response to which an attendant can provide the driver with an alternative code (e.g., a printed image of the alternative code) that the driver can use (e.g., present the alternative code to the image capture/code reader device 708) to establish the parking meter stop time. In an example embodiment, a vending machine, a kiosk, or other publicly accessible interface, console, or station (e.g., that monitors and/or manages the metering of multiple parking spaces) is configured to allow a driver or other person to initiate or submit a request to be provided with an alternative code.

In an example embodiment, the parking meter 701 includes an interactive user interface, a graphical user interface, or display configured to provide a visual representation of one or more of, for example: an acknowledgement that the association, the start time and/or the stop time has been established, a prompt or request for additional information or user inputs (e.g., to associate a new/different/valid account with the generated code, to renew registration/license/insurance, to authorize transfer of funds for renewal of driver's license/vehicle registration/automobile insurance), information and/or instructions (e.g., hours when the parking space can be used, maximum amount of time permitted to park in the space/lot, how to obtain an alternative code if an authorized code generator device is lost, misplaced, or inoperative), a notification (e.g., a message notifying a person who has been in California for 20 days that they need to register their vehicle if they now reside in California), and a warning (e.g., a text message, such as: “When you were driving in [town, street] on [day] at approximately [time], you were traveling at an excessive speed. This is a courtesy warning. Next time, you will receive a citation and fine, and possibly additional penalties, impounding of your vehicle, and/or suspension or revocation of your driver's license as may be appropriate or required under the law.”)

In an example embodiment, the parking meter 701 (and/or a remote processing location/center in communication with the parking meter) is configured to access supplemental information identifying and/or in relation to a vehicle, person, entity and/or object associated with the account. In another example embodiment, the parking meter 701 (and/or a remote processing location/center in communication with the parking meter) is configured to provide or facilitate access to the supplemental information, parking meter usage information, and/or notifications relating to said information by one or more of, for example: an owner, an operator, or a vendor of the parking meter, a maintenance or service company, authorized operators and users of a system for monitoring and managing transportation infrastructure and locations of vehicles therein, a law enforcement agency, a parking enforcement agency, a government agency, a company or other private-sector entity or organization, a lienholder, an insurance company, authorized or approved individuals or groups, an owner or a registered owner of the vehicle, and a person or persons authorized or approved by the owner and/or the registered owner of the vehicle.

In an example “Parking Meter Digital Registration” technology and/or methodology, parking meters are provided with a code and/or a code generating device. In this example, a driver of a vehicle uses an image capture/code reader device such as a mobile telephone, a smartphone, or a PCD configured with a camera and with code reader software (and/or configured to utilize or access code reader software) to scan or capture an image of the code in order to activate the parking meter and/or establish a parking meter start time. Upon return, the driver can scan or image the code again and initiate and/or authorize a process of paying a parking fee for the duration of the time the vehicle has been parked. For example, the payment is automatically deducted from an account which has been previously set up or charged to a credit card.

In another example “Parking Meter Digital Registration” technology and/or methodology, parking meters are provided with an image capture/code reader device. In this example, a driver of a vehicle uses a code generator device such as a mobile telephone, a smartphone, or a PCD configured with a display and with code generator software (and/or configured to utilize or access code generator software) to generate an image of the code, which is read by the parking meter in order to activate the parking meter and/or establish a parking meter start time. Upon return, the image capture/code reader device (of the parking meter) is used to scan or image the code again and initiate and/or authorize a process of paying a parking fee for the duration of the time the vehicle has been parked. For example, the payment is automatically deducted from an account which has been previously set up or charged to a credit card.

In either case, a driver no longer has to have ready access to coins in order to pay for parking and avoids the unfortunate and all-too-frequent necessity of having to return to “feed” the parking meter. In an example embodiment, information identifying the parking meter and/or parking space is synchronized or associated with information pertaining to the vehicle and/or the driver. For example, information obtained from the driver's mobile telephone, smartphone, or PCD (e.g., during the process of activating the parking meter) is utilized to access the VIN of the vehicle from a database. In an example embodiment, an account (e.g., an account associated with the VIN) is automatically charged the parking fee. In an example embodiment, the parking fee is charged, debited, or billed to an account associated with, for example: an identified vehicle (e.g., identified by VIN), a mobile telephone, a smartphone, a PCD, an image capture device, a code reader device (e.g., a bar code scanner/reader), a code generator device, or other data input mechanism (e.g., that facilitates providing a code to a parking meter or an image capture/code reader device).

By way of further example, a registered owner of a vehicle is associated with an account that is linked to a credit card and/or allowed or required to maintain a deposit account in order to have credit available from which parking fees can be drawn (e.g., in association with a particular VIN). When a vehicle is parked in a specific parking space, then, without depositing coins, based upon the duration of use, an account is charged by a computer system. In this manner, the account (e.g., associated with the VIN) is only charged for the time of use while parked. As a consequence, parking fees are determined and charged with greater precision representing an advantage for drivers as compared to the current system where most people leave their parking space with unused time left on a meter. In an example embodiment, if the account to be charged lacks sufficient funds to pay a parking fee, a computer (or processing center of the like) can be programmed to automatically initiate a process of transmitting a citation and/or bill, by e-mail and/or mail, to the registered owner.

In an example embodiment, the VIN is transmitted and/or detected, and a computer program is used to identify when a particular vehicle is parked for more than an allowable period of time at a parking space and to automatically issue a citation to the registered owner. For example, a citation can be issued for a car parked in public streets with an expired registration. In another example, a citation is issued to someone associated with a vehicle parked in a no-parking zone or a red-zone. Due to the relatively small number of parking enforcement officers as compared to the number of vehicles (in a typical city or town), an accurate and substantially completely automated citation system can significantly increase parking revenues generated and can also eliminate or reduce the need for parking enforcement officers.

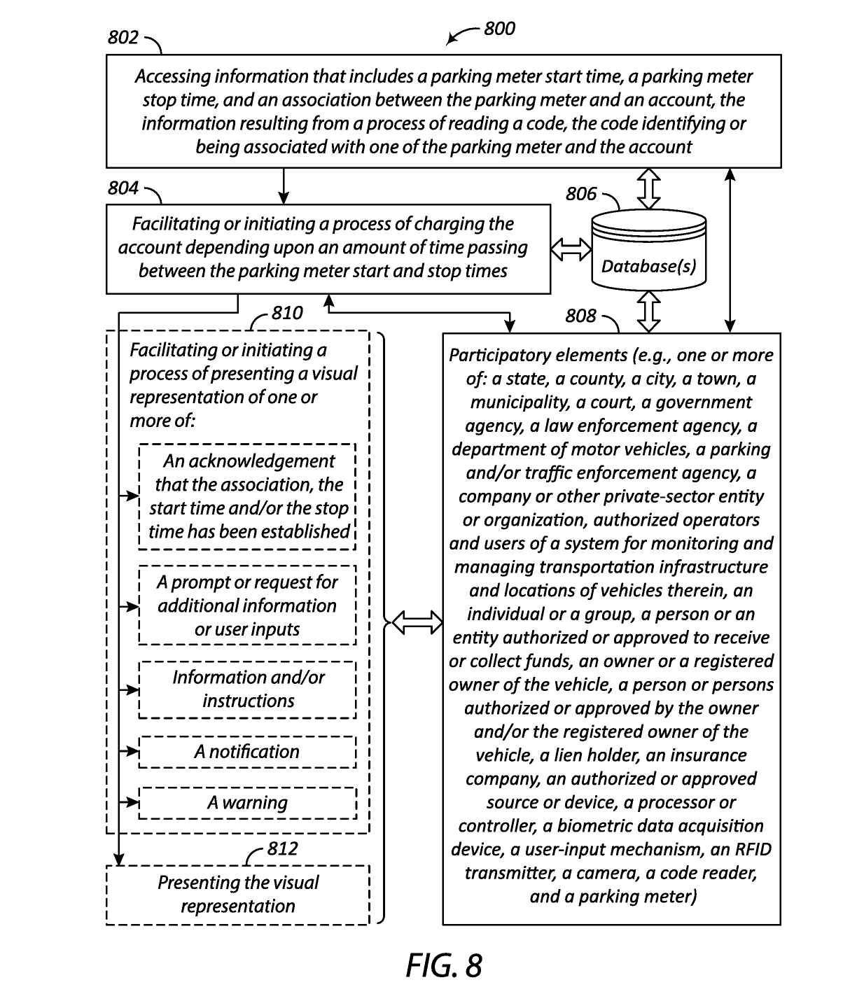

FIG. 8 shows an example implementation of a method 800 for monitoring and managing usage of a parking space. At 802, information is accessed, namely, information that includes a parking meter start time, a parking meter stop time, and an association between the parking meter and an account, the information resulting from a process of reading a code, the code identifying or being associated with one of the parking meter and the account. In an example embodiment, the association is between a uniquely identified parking meter and an account. In an example embodiment, the association is established at a parking meter start time. In an example embodiment, the process of reading a code includes reading the code two times or reading code at two different times (e.g., at a parking meter start time and at a parking meter stop time).

In example embodiments, signals transmitted from a parking meter and/or a vehicle are received (e.g., and referring also to FIGS. 1, 6, and 7, by one or more of, for example: a network, satellites, one or more processing centers, one or more system interfacing elements, one or more image capture/code reader devices, and one or more code generator devices. The signals can include information relating to (e.g., identifying) one or more of, for example: the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle. In an example embodiment, the signals are received over an interval of time.

At 804, a process of charging the account depending upon an amount of time passing between the parking meter start and stop times is facilitated or initiated. In an example embodiment, the signals and/or information can be processed to identify in association with the vehicle a circumstance that satisfies (predetermined or other) criteria. The signals and/or information are processed, for example, by one or more processing centers and/or one or more of the system interfacing elements (e.g., operators, users, and/or devices involved in or facilitating a system for monitoring and managing transportation infrastructure and locations of vehicles therein). In example embodiments, the signals and/or information are processed at least in part by participatory elements 808. By way of example, the participatory elements 808 include one or more of: a state, a county, a city, a town, a municipality, a court, a government agency, a law enforcement agency, a department of motor vehicles, a parking and/or traffic enforcement agency, a company or other private-sector entity or organization, authorized operators and users of a system for monitoring and managing transportation infrastructure and locations of vehicles therein, an individual or a group, a person or an entity authorized or approved to receive or collect funds, an owner or a registered owner of the vehicle, a person or persons authorized or approved by the owner and/or the registered owner of the vehicle, a lienholder, an insurance company, an authorized or approved source or device, a processor or controller, a biometric data acquisition device, a user-input mechanism, an RFID transmitter, a camera, a code reader, and a parking meter. In example embodiments, information, data, and/or programs stored in one or more database(s) 806 is utilized in processing the signals and/or information. The database(s) 806 include one or more of, for example, a law enforcement database, a DMV database, an insurance database, and a lienholder database. It should be understood that the database(s) 806 can include additional database(s) pertaining, for example, to other types of information and/or data as described herein.

Example methodologies and technologies described herein present, or facilitate a presentation of, visual representations pertaining to a vehicle, a circumstance, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle, information, and/or notifications. Example implementations utilize a network and/or communications links and one or more interfaces and/or displays are to present the visual representations. The circumstances include, by way of example, one of more of the previously discussed circumstances, the discussion of which is incorporated herein by reference.

At 810, an action or a process is facilitated, controlled, or initiated (e.g., by one or more of the participatory elements 808). The action or process involves presenting a visual representation of one or more of, for example: an acknowledgement that the association, the start time and/or the stop time has been established, a prompt or request for additional information or user inputs, information and/or instructions, a notification, and a warning. In an example embodiment, a method for monitoring and managing usage of a parking space includes facilitating or initiating a process of presenting (e.g., at an interactive user interface, a graphical user interface, or a display) a visual representation of one or more of, for example, an acknowledgement that the association, the start time and/or the stop time has been established, a prompt or request for additional information or user inputs (e.g., to associate a new/different/valid account with the generated code, to renew registration/license/insurance, to authorize transfer of funds for renewal of driver's license/vehicle registration/automobile insurance), information and/or instructions (e.g., hours when the parking space can be used, maximum amount of time permitted to park in the space/lot, how to obtain an alternative code if an authorized image capture/code reader device or code generator device is lost, misplaced, or inoperative), a notification (e.g., a message notifying a person who has been in California for 20 days that they need to register their vehicle if they now reside in California), and a warning (e.g., a text message, such as: “When you were driving in [town, street] on [day] at approximately [time], you were traveling at an excessive speed. This is a courtesy warning. Next time, you will receive a citation and fine, and possibly additional penalties, impounding of your vehicle, and/or suspension or revocation of your driver's license as may be appropriate or required under the law.”). In an example embodiment, the process can also include processing the signals and/or the information to identify in association with the parking meter and/or the vehicle a circumstance that satisfies criteria for facilitating, controlling, or initiating an action or a process involving one or more of providing information, providing a notification, transferring funds, and issuing a ticket, a citation, a warning, or other communication.

At 812, a visual representation is presented (e.g., to one or more of the participatory elements 808). By way of example, the visual representation presented is a visual representation of one or more of: the parking meter, a mobile telephone or other PCD, a device that generates the code, a device that reads the code, a device, interface, or display that is separate from the parking meter (e.g., a workstation, interface, vending machine, kiosk), and a device, interface, or display that is remotely located in relation to the parking meter (e.g., a processing/monitoring center, facility, or station).

An example method for monitoring and managing usage of a parking space further includes providing, facilitating, or initiating a communication that includes a resource (e.g., URL) or other information that provides access to a receipt (e.g., PDF file/image) or other documentation or information relating to a charge to the account and/or usage of the parking meter.

An example method for monitoring and managing usage of a parking space further includes accessing, or facilitating or initiating a process of providing access to, supplemental information pertaining to one or more of a vehicle, a person, an entity, and an object associated with the account. In an example embodiment, the method for monitoring and managing usage of a parking space further includes accessing, or facilitating or initiating a process of providing access to, the supplemental information, parking meter usage information, and/or notifications relating to said information by one or more of, for example: an owner, an operator, or a vendor of the parking meter, a maintenance or service company, authorized operators and users of a system for monitoring and managing transportation infrastructure and locations of vehicles therein, a law enforcement agency, a parking enforcement agency, a government agency, a company or other private-sector entity or organization, a lienholder, an insurance company, authorized or approved individuals or groups, an owner or a registered owner of the vehicle, and a person or persons authorized or approved by the owner and/or the registered owner of the vehicle.

Although the present invention has been described in terms of the example embodiments above, numerous modifications and/or additions to the above-described embodiments would be readily apparent to one skilled in the art. It is intended that the scope of the present invention extend to all such modifications and/or additions.

1. An apparatus for monitoring and managing transportation infrastructure and locations of vehicles therein, the apparatus comprising:
an electronic tracking device with a transmitter that generates signals that include information relating to one or more of a vehicle equipped with the electronic tracking device, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle;
wherein the electronic tracking device includes a communications device facilitating one or more of cellular, radio and satellite communications;
wherein the electronic tracking device is configured to receive and respond to interrupts and/or commands from a parking meter.

2. The apparatus of claim 1, wherein the information includes vehicle identification information that uniquely identifies the vehicle equipped with the electronic tracking device.

3. The apparatus of claim 2, wherein the electronic tracking device is configured such that the vehicle identification information cannot be changed or prevented from being transmitted during normal operation of the electronic tracking device.

4. The apparatus of claim 1, wherein the signals are transmitted over an interval of time.

5. The apparatus of claim 1, wherein the electronic tracking device includes a GPS tracking device or unit.

6. (canceled)

7. The apparatus of claim 1,
wherein the electronic tracking device is configured to receive and respond to interrupts and/or commands from one or more of
authorized or approved sources and/or devices,
biometric data acquisition devices,
user-input mechanisms,
RFID transmitters, and
speed camera transmitters.

8. The apparatus of claim 1,
wherein the interrupts and/or commands facilitate, control, or initiate one or more of
modifying the information transmitted or adding additional information to the signals transmitted by the electronic tracking device,
providing information and/or notifications to authorized operators and users of a system for monitoring and managing transportation infrastructure and locations of vehicles therein,
controlling an interactive user interface, a graphical user interface, or a display inside the vehicle, on a mobile communications device, and/or at a remote location to provide one or more of information, instructions, a notification, a warning, and a prompt,
transferring funds from an account associated with one or more of the vehicle, an owner, a driver, a custodian, or a passenger of the vehicle, a person, an animal, an object within, secured to, or transported by the vehicle, and a person, an entity, an object, a status, a condition, an event, an indication, or an interrupt associated with the vehicle to one or more other accounts, and
issuing a ticket, citation, warning or other communication.

9. The apparatus of claim 8,
wherein the authorized operators and users include one or more of
a law enforcement agency,
a government agency,
a state, a county, a city, a town, or a municipality,
a company or other private-sector entity or organization,
an individual or a group provided with an authorized or approved device,
an owner or a registered owner of the vehicle, and
a person authorized or approved by the owner and/or the registered owner.

10. The apparatus of claim 8,
wherein the one or more other accounts are associated with one or more of
an entity authorized or approved to receive or collect funds in relation to a parking or moving violation associated with the vehicle,
a government agency,
a state, a county, a city, a town, or a municipality,
a court,
a lienholder, and
an insurance company.

11. A method for monitoring and managing transportation infrastructure and locations of vehicles therein, the method comprising:
receiving signals transmitted from a vehicle equipped with a transmitter that generates the signals, the signals including information relating to one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle; and
processing the signals and/or information to identify in association with the vehicle a circumstance that satisfies criteria for facilitating, controlling, or initiating an action or a process involving one or more of
providing information,
providing a notification,
transferring funds, and
issuing a ticket, a citation, a warning, or other communication;
wherein the circumstance is an identification or a determination that a registration associated with the vehicle is an out-of-state vehicle registration.

12. The method of claim 11, wherein the signals are received over an interval of time.

13. The method of claim 11, further comprising:
presenting a visual representation of one or more of
the vehicle and/or the circumstance,
information and/or instructions,
a notification,
a warning, and
a prompt.

14-15. (canceled)

16. A method for monitoring and managing transportation infrastructure and locations of vehicles therein, the method comprising:
receiving signals transmitted from a vehicle equipped with a transmitter that generates the signals, the signals including information relating to one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle; and
processing the signals and/or information to identify in association with the vehicle a circumstance that satisfies criteria for facilitating, controlling, or initiating an action or a process involving one or more of
providing information,
providing a notification,
transferring funds, and
issuing a ticket, a citation, a warning, or other communication;
wherein the circumstance is an identification or a determination that a tax associated with one or more of the vehicle, an owner, a driver, a custodian, or a passenger of the vehicle, a person, an animal, or an object within, secured to, or transported by the vehicle, and a person, an entity, or an object associated with the vehicle is, or will be, late, overdue, unpaid, delinquent, and/or in default.

17. A method for monitoring and managing transportation infrastructure and locations of vehicles therein, the method comprising:
receiving signals transmitted from a vehicle equipped with a transmitter that generates the signals, the signals including information relating to one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle; and
processing the signals and/or information to identify in association with the vehicle a circumstance that satisfies criteria for facilitating, controlling, or initiating an action or a process involving one or more of
providing information,
providing a notification,
transferring funds, and
issuing a ticket, a citation, a warning, or other communication;
wherein the circumstance is a crime, reported, detected or suspected criminal activity, or an identification or a determination of a crime or criminal activity involving or associated with an object within, secured to, or transported by the vehicle, the object being other than a person or animal.

18. A method for monitoring and managing transportation infrastructure and locations of vehicles therein, the method comprising:
receiving signals transmitted from a vehicle equipped with a transmitter that generates the signals, the signals including information relating to one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle; and
processing the signals and/or information to identify in association with the vehicle a circumstance that satisfies criteria for facilitating, controlling, or initiating an action or a process involving one or more of
providing information,
providing a notification,
transferring funds, and
issuing a ticket, a citation, a warning, or other communication;
wherein the circumstance is an identification or a determination of a status associated with a driver or a passenger of the vehicle, said status being that of a felon, a parolee, or a registered sex offender.

19-23. (canceled)

24. The method of claim 11, wherein the notification pertains to
vehicle registration requirements for new residents of the state.

25. The method of claim 11, wherein transferring funds includes
transferring funds from an account associated with one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle to one or more other accounts.

26. The method of claim 25, wherein the one or more other accounts are associated with one or more of an entity authorized to receive or collect funds in relation to a moving violation associated with the vehicle, a state agency, a city, a municipality, a court, a lienholder, and an insurance company.

27. The method of claim 11, wherein the ticket, citation, warning or other communication is electronically issued.

28. The method of claim 11, further comprising:
adding information pertaining to one or more of the vehicle, an owner, a driver, a custodian, or a passenger of the vehicle, a person, an animal, or an object within, secured to, or transported by the vehicle, a person, an entity, an object, a status, a condition, an event, an indication, or an interrupt associated with the vehicle, the circumstance, and a location, an area, a region, or an environment within which the vehicle is located, or that the vehicle is approaching or departing from, to a database and/or using the information to update a database.

29. The method of claim 11, further comprising:
adding to or modifying the information, the circumstance, and/or the criteria in response to an input or inputs provided by
a parking meter.

30. An apparatus for monitoring and managing usage of a parking space, the apparatus comprising:
a parking meter that facilitates providing information including a parking meter start time, a parking meter stop time, and an association between the parking meter and an account, and initiates or requests a transaction in which the account is charged depending upon an amount of time passing between the start time and the stop time.

31. The apparatus of claim 30, wherein the association is established utilizing a code.

32. The apparatus of claim 31, wherein the code includes information that uniquely identifies a vehicle.

33. The apparatus of claim 31, wherein the parking meter start and stop times are established utilizing the code.

34. The apparatus of claim 33, wherein the parking meter is configured to establish the stop time utilizing an alternative code.

35. The apparatus of claim 31, wherein the code is a bar code.

36. The apparatus of claim 31, wherein the code is provided on or generated by the parking meter.

37. The apparatus of claim 36, wherein the code is located on a metal plate on an external portion of the parking meter and/or presented on a display of the meter.

38. The apparatus of claim 36, wherein the parking meter is configured with or utilizes or accesses code generator software to generate the code.

39. The apparatus of claim 31, wherein the association is established by a device that captures an image of the code and is configured with or utilizes or accesses code reader software that processes the image to read the code.

40. The apparatus of claim 39, wherein the device is a mobile telephone, a smartphone, or a PCD configured with a camera and configured with or configured to utilize or access the code reader software.

41. The apparatus of claim 39, wherein the parking meter is configured to transmit or initiate a process of providing a communication to the device.

42. The apparatus of claim 41, wherein the communication is provided directly from the parking meter, or from a remote processing location or center.

43. The apparatus of claim 41, wherein the communication includes a resource or other information that provides a user of the device with access to a receipt or other documentation or information relating to the transaction and/or usage of the parking meter.

44. The apparatus of claim 31, wherein the code is provided on or generated by a mobile telephone, a smartphone, or a PCD.

45. The apparatus of claim 44, wherein the mobile telephone or other PCD is configured with or utilizes or accesses code generator software to generate the code.

46. The apparatus of claim 44, wherein the parking meter is equipped with a device that captures an image of the code and is configured with or utilizes or accesses code reader software that processes the image to read the code.

47. The apparatus of claim 40, wherein the parking meter is configured to transmit or initiate a process of providing a communication to the mobile telephone, the smartphone, or the PCD.

48. The apparatus of claim 47, wherein the communication is provided directly from the parking meter, or from a remote processing location or center.

49. The apparatus of claim 47, wherein the communication includes a resource or other information that provides a user of the mobile telephone, the smartphone, or the PCD with access to a receipt or other documentation or information relating to the transaction and/or usage of the parking meter.

50. The apparatus of claim 30, wherein the association is established by a device that captures an image of the code and is configured with or utilizes or accesses code reader software that processes the image to read the code.

51. The apparatus of claim 30, wherein the parking meter includes an interactive user interface, a graphical user interface, or display configured to provide a visual representation of one or more of
an acknowledgement that the association, the start time and/or the stop time has been established,
a prompt or request for additional information or user inputs,
information and/or instructions,
a notification, and
a warning.

52. The apparatus of claim 30, wherein the parking meter is configured to access supplemental information identifying and/or in relation to a vehicle, person, entity and/or object associated with the account.

53. The apparatus of claim 52, wherein the parking meter is configured to provide or facilitate access to the supplemental information, parking meter usage information, and/or notifications relating to said information by one or more of
an owner, an operator, or a vendor of the parking meter,
a maintenance or service company,
authorized operators and users of a system for monitoring and managing transportation infrastructure and locations of vehicles therein,
a law enforcement agency,
a parking enforcement agency,
a government agency,
a company or other private-sector entity or organization,
a lienholder,
an insurance company,
authorized or approved individuals or groups,
an owner or a registered owner of the vehicle, and
a person or persons authorized or approved by the owner and/or the registered owner of the vehicle.

54. A method for monitoring and managing usage of a parking space, the method comprising:
accessing information that includes a parking meter start time, a parking meter stop time, and an association between the parking meter and an account, the information resulting from a process of reading a code, the code identifying or being associated with one of the parking meter and the account; and
facilitating or initiating a process of charging the account depending upon an amount of time passing between the parking meter start and stop times.

55. The method of claim 54, further comprising:
facilitating or initiating a process of presenting a visual representation of one or more of
an acknowledgement that the association, the start time and/or the stop time has been established,
a prompt or request for additional information or user inputs,
information and/or instructions,
a notification, and
a warning.

56. The method of claim 55, wherein the visual representation is presented at one or more of
the parking meter,
a mobile telephone, a smartphone, or a PCD,
a device that generates the code,
a device that reads the code,
a device, interface, or display that is separate from the parking meter, and
a device, interface, or display that is remotely located in relation to the parking meter.

57. The method of claim 54, further comprising:
providing, facilitating, or initiating a communication that includes a resource or other information that provides access to a receipt or other documentation or information relating to a charge to the account and/or usage of the parking meter.

58. The method of claim 54, further comprising:
accessing, or facilitating or initiating a process of providing access to, supplemental information pertaining to one or more of a vehicle, a person, an entity, and an object associated with the account.

59. The method of claim 58, further comprising:
accessing, or facilitating or initiating a process of providing access to, the supplemental information, parking meter usage information, and/or notifications relating to said information by one or more of
an owner, an operator, or a vendor of the parking meter,
a maintenance or service company,
authorized operators and users of a system for monitoring and managing transportation infrastructure and locations of vehicles therein,
a law enforcement agency,
a parking enforcement agency,
a government agency,
a company or other private-sector entity or organization,
a lienholder,
an insurance company,
authorized or approved individuals or groups,
an owner or a registered owner of the vehicle, and
a person or persons authorized or approved by the owner and/or the registered owner of the vehicle.
